(19) United States
(12) Patent Application Publication
(10) Pub. No.: US 2011/0239117 A1
(43) Pub. Date: Sep. 29, 2011

(54) Natural User Interaction in Shared Resource Computing Environment

(75) Inventors: Paul C. Sutton, Seattle, WA (US); Shahram Izadi, Cambridge (GB); Behrooz Chitsaz, Bellevue, WA (US)

(73) Assignee: Microsoft Corporation, Redmond, WA (US)

(21) Appl. No.: 12/732,018

(22) Filed: Mar. 25, 2010

(51) Int. Cl. G06F 3/048; G06F 3/00; H04L 9/32

(52) U.S. Cl. 715/706; 715/753; 726/3; 715/769

(57) ABSTRACT

Sharing and exchanging information in a Shared Resource Computing (SRC) environment are disclosed. Example systems include a shared resource computing server and a plurality of peripheral devices. The SRC server may include functionality configured to share and exchange information between the peripheral devices, including functionality to determine the physical position of the peripheral devices, functionality to associate avatars to the peripheral devices, and functionality to display the avatars within a representation of the environment. Alternate embodiments may also include functionality for user authentication and functionality for sending a document between peripheral devices.

### BACKGROUND

Processing and memory capabilities of desktop and laptop computers have increased such that conventional personal computers now have greater computing capability than is needed for many computationally simple tasks such as web browsing, e-mail, and word processing. This excess capability can enable a single computer to support multiple users simultaneously. By attaching several display devices, such as monitors, and several input devices, such as keyboards and mice, multiple users can share a single computer. Using one computer to support multiple users simultaneously is known as Shared Resource Computing (SRC). Schools and libraries in particular may benefit from SRC rather than conventional personal computer systems because computationally simple tasks are likely to predominate (e.g., web browsing rather than 3-D graphics) and the cost per seat of ownership and maintenance is less for an SRC system than an equivalent number of traditional computers.

A SRC environment may be distinguishable from a network. In the most general sense, a network entails a number of devices that are capable of stand-alone operation, coupled together for the purposes of communicating with one another. In a network, computational resources may be shared, but for convenience, generally, not out of necessity. A network may be made up of a number of peer devices connected together in a variety of schemes, a server connected to a number of client devices, or some combination thereof In general, if a client device is disconnected from a network, the client device is still capable of at least general purpose computing, if not running computationally intense applications. Further, each device within a network is generally clocked individually, and a method is employed to synchronize timing across the network.

In contrast, SRC generally entails a single computing resource that is shared by a number of peripheral interface devices, where the peripheral devices have limited or no general purpose computing resources of their own. The peripheral devices in an SRC environment generally rely on a server for nearly all functionality, including computational functionality to run basic applications. Each peripheral device shares the central processing unit(s) (CPU) of the server, as well as the system memory and main bus(es) of the server. Each peripheral device is subject to the basic input output system (BIOS) of the server. In general, if a peripheral device in an SRC system is disconnected from the server, the device may lose the ability to run applications, or perform basic computational tasks. Further, the peripheral devices in an SRC system generally share the system clock of the server, which provides the timing for the SRC system.

Within a generalized example SRC system, users on the system may be collaborating in a common room. While the users may be co-located, it can be inconvenient or inefficient for users to have limited or no ability to share or exchange information electronically, such as documents, between themselves or across their individual terminals.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This disclosure establishes mechanisms through which information may be shared between devices within a Shared Resource Computing (SRC) environment. In one example embodiment, a system for sharing and exchanging information between devices includes a SRC server and multiple peripheral devices sharing a common computing resource, where the SRC server generally provides the common computing resource. In an example, the SRC server may comprise a processor, memory coupled to the processor, and a number of modules providing functionality for the sharing and exchanging of information. For example, the server may comprise a calibration module configured to detect a physical location of each of the peripheral devices as well as determine a relative position of the devices. The server may also comprise an avatar module configured to associate an avatar to each of the peripheral devices. Further, the server may comprise a graphical user interface (GUI) module configured to display the avatars within a representation of a physical environment. For example, the avatars may be displayed based on their relative position and physical location within the physical environment. In one implementation, the SRC server may also include a sentry module configured to authenticate a user of each of the peripheral devices to a session operative on the SRC server, and to provide the user with access to resources stored on the SRC server. In another implementation, the SRC server may also include a document sharing module configured to send a document to one or more of the peripheral devices. For example, a document may be sent to a peripheral device through a drag and drop operation of a symbol of the document, to an avatar associated to the peripheral device. This drag and drop operation may be performed, for example, via the GUI.

Another embodiment describes a method for sharing and exchanging information between devices in a shared resource computing environment. In one example, the method includes detecting a location of each of a number of peripheral devices sharing a common server, and determining a position of each of the peripheral devices. The method also includes associating an avatar to each of the peripheral devices. In one embodiment, the avatar may be configured to represent a user of the peripheral device for the purpose of sending and receiving documents between sessions operative on the server. Further, the method may include authenticating each user of a peripheral device to a session operative on the server. The method also may include generating a GUI for displaying the avatars within a representation of the physical environment. In one embodiment of the method, the avatars are displayed on the GUI in a spatially relative position corresponding to the physical location of each of the peripheral devices within the physical environment.

In a further embodiment, a method for sharing and exchanging information between devices in a shared resource computing environment includes authenticating a user of a peripheral device to a session operative on the server in the environment. The method includes generating a GUI to display a representation of the environment, and to display an avatar of the user of the peripheral device. The method further includes sending a document to the peripheral device. For example, the document may be sent using a drag and drop operation of a symbol of the document to the avatar of the user of the peripheral device. In an embodiment, the drag and drop operation is performed via the GUI. In an embodiment of the method, the document being sent may be open for viewing and or editing at the time it is sent.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of a logical layout of an illustrative architecture of an SRC system including a server and multiple peripheral devices.

FIG. 2 is a schematic diagram of a physical layout of the illustrative architecture of FIG. 1.

FIG. 3 is a block diagram of an illustrative SRC server usable in the architecture of FIG. 1.

FIG. 4 is a schematic diagram illustrating moving and/or sharing a document between peripheral devices, according to an example embodiment.

FIG. 5 is an illustration of a document opened in a document viewing application, according to an example embodiment.

FIG. 6 is a flowchart illustrating a method of configuring an SRC environment, according to an example embodiment.

FIG. 7 is a flowchart illustrating a method of sharing and exchanging a document between devices in an SRC environment, according to an example embodiment.

FIG. 8 is a flowchart illustrating a method of moving a document between peripheral devices, according to an example embodiment.

### DETAILED DESCRIPTION

The subject matter of this disclosure relates generally to sharing and exchanging information between devices and users, particularly in the context of shared resource computing. An illustrative shared resource computing (SRC) system may have only one computer (e.g., a device with a processor and a memory) but many user terminals (peripheral devices). Other SRC systems may include multiple computers each with one or more terminals. Descriptions of example SRC systems that describe a single SRC server apply equally to like systems having multiple SRC servers.

In one embodiment, an SRC system environment may be formed by coupling two or more SRC servers, where the functions and capabilities of the SRC system may be performed across or between the multiple SRC servers. For example, one SRC server may exist in a school or workspace, and another SRC server may exist in a remote datacenter accessible via the Internet, where these two SRC servers form a single SRC system, such that the embodiments described below may be used, for example, to share or move documents between the different SRC servers, and users may or may not be aware that multiple SRC servers are involved.

Terminals in an SRC environment generally rely on a server for nearly all functionality, including basic computational functionality. Each terminal or peripheral device may share the core devices of the server, including central processing unit(s), system memory, main buses, system cache, and the like. Each peripheral device is subject to the basic input output system (BIOS) of the server. In general, if a peripheral device in an SRC environment is disconnected from the server, the device may lose the ability to run applications, or perform basic computational tasks. Further, the peripheral devices in an SRC environment generally share the system clock of the server, which provides the timing for the SRC system.

Users on an SRC system may have access to the same versions of the same applications, and corresponding working files. Management of the SRC system may be management of a single SRC server, including updates to antivirus protection, maintaining user lists without domains, managing applications and content, controlling file sharing, performing backups, and the like. Additionally, an administrator may set up session-based work streams on a single machine, and suspend or save sessions and then resume them as part of maintenance routines, for example.

While each peripheral device is sharing the computing resources of a common computer, each terminal or peripheral device may be displaying a separate and independent session, a shared session, or multiple sessions. A session may include the unique interaction a user experiences when the user is signed in, or authenticated. For example, a session may include the user's individual desktop and associated individual settings, preferences, and applications. One example of a session may be a virtual machine running on the server, and displaying a desktop on a peripheral device. Another example of a session may be a remote access session operative on a peripheral device, such as Terminal Services (TS) Web Access, or Remote Desktop Services (RDS), both available from Microsoft Corporation. In other examples, a session may be another type of similar user experience. In each of these examples, the session is independent, while the computational resources that run the sessions are shared.

### Illustrative Shared Resource Computing (SRC) System

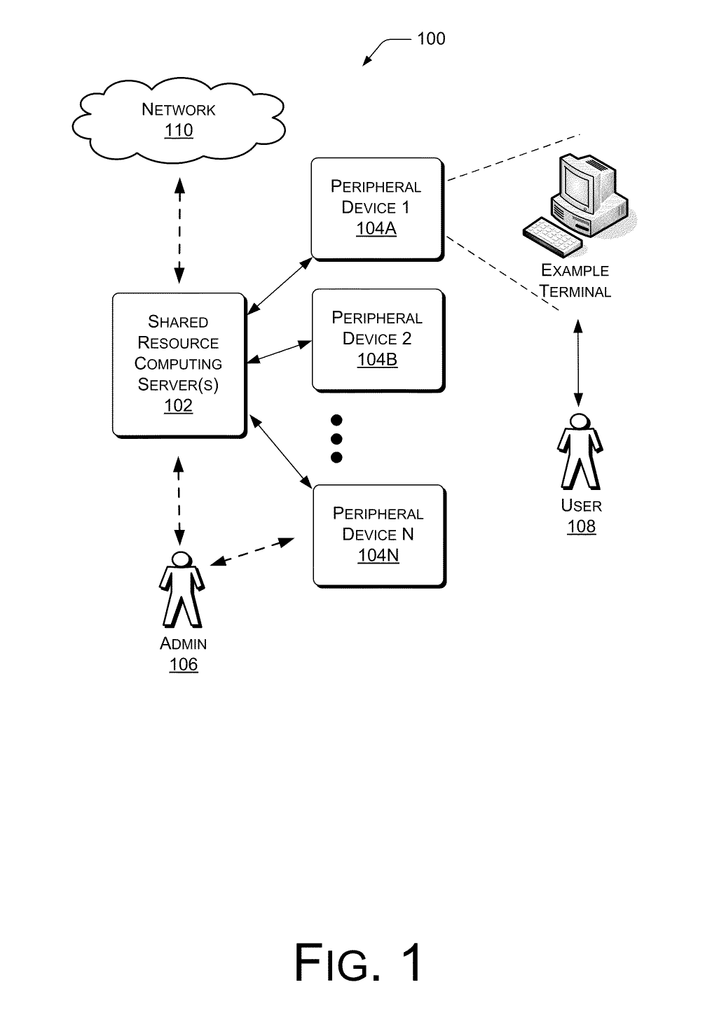

FIG. 1 is a schematic diagram showing elements and logical connections of an illustrative architecture 100 of an SRC system. The SRC system illustrated in FIG. 1 includes an SRC server 102 and a number of peripheral devices (or terminals) 104. In one example, an SRC server 102 has a direct connection to each peripheral device 104. In an embodiment, the direct connection between a peripheral device 104 and the SRC server 102 is a wired connection, such as a universal serial bus (USB) connection, for example, or another type of local I/O connection. In an alternate embodiment, a direct connection between a peripheral device 104 and the SRC server 102 may be a wireless connection, optical connection, or the like. In one alternate embodiment, direct connections between peripheral devices 104 and an SRC server 102 are comprised of both wired and wireless connections. However connected, each peripheral device 104 generally relies on the SRC server 102 for general computing resources as explained above and below.

An SRC server 102 in an example SRC system may be a conventional desktop or laptop computer or a virtual machine in a datacenter. Other examples of SRC servers include conventional Web servers, set-top boxes, gaming consoles, cell phones, personal digital assistants, and the like. Although termed a “server,” the SRC server 102 is not necessarily connected to a network, and need not be for the purposes of this discussion. However, in some example embodiments, the SRC server 102 may be connected to a network 110, such as an intranet, the Internet, and the like.

By way of example, an administrator 106 is illustrated as having access to the SRC server(s) 102 and also to a peripheral device 104. An administrator 106 may manage the SRC system from the SRC server 102 and/or use the SRC server 102 as a conventional computer. If an SRC system is deployed in a classroom setting, the administrator 106 may be a teacher rather than an IT technician. The administrator 106 may have access to advanced functionality on the SRC system, which may include the rights to system level configurations, the authentication of users, granting or denying access to resources on the system, and the like.

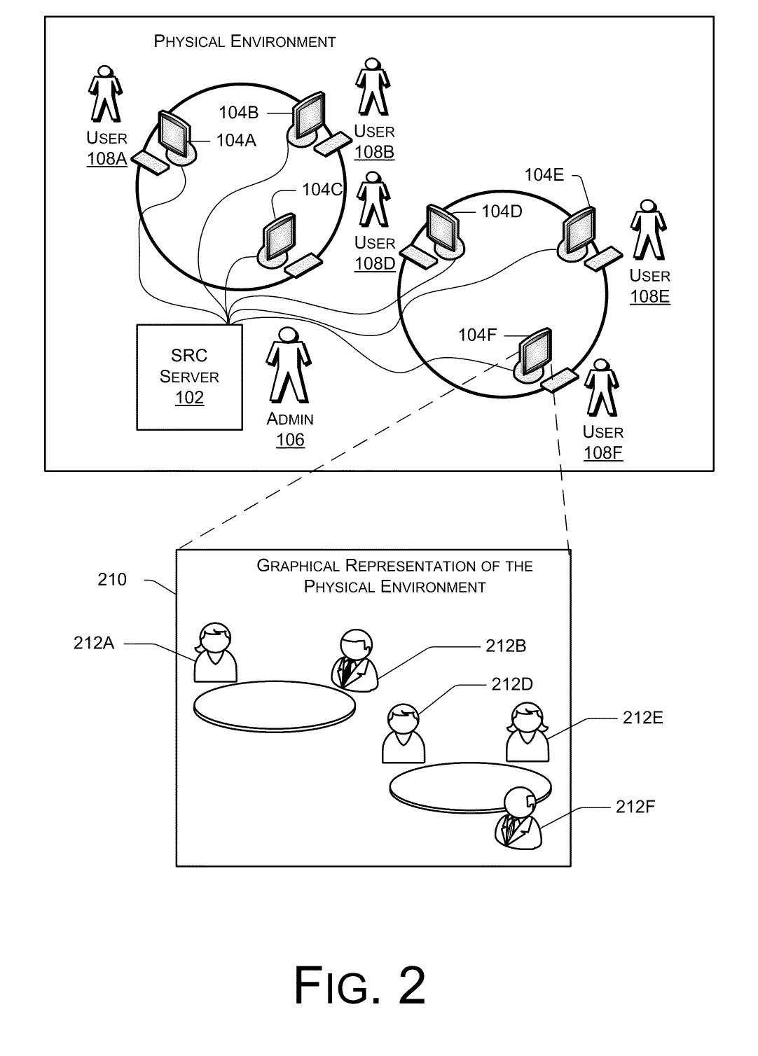

FIG. 2 shows a schematic diagram of a physical layout of the illustrative architecture 100 of FIG. 1. The illustration in FIG. 2 shows an SRC system that may be in a conference room at a business, a school setting, or the like. In a home setting, an SRC system may include a single computing device, for example, a conventional desktop computer that functions as the SRC server 102 with a multitude of other devices as the peripheral devices 104. Similarly, in a business setting a company may have a single computing device or a virtual machine in a datacenter that functions as the SRC server 102 for a group of employees who each have a terminal 104 at their respective workstations. Depending on the size of the company and the number of employees, there may be multiple SRC servers 102 coupled together by local input/output (I/O) connections, network connections, or both, forming an intranet, a server farm, or other local or wide area network.

As described above, an example SRC system as shown in FIGS. 1 and 2 also includes several user terminals 104. Six user terminals 104A, 104B, 104C, 104D, 104E, and 104F are shown in FIG. 2. However, a greater or lesser number of terminals 104 may be connected to the SRC server 102. The terminals 104 may comprise input and output devices without separate processors or memory. In other implementations, the terminals 104 may be thin clients with limited processors and/or memory, or other devices capable of acting as a terminal 104. While peripheral devices 104 have been described as having limited or no functionality when not connected to a server 102, in alternate embodiments the peripheral devices 104 may have additional functionality that is generally not used when the peripheral device 104 is connected to the SRC server 102. Thus, in some embodiments, such devices as laptops, terminals with a monitor and keyboard similar to a desktop computer, a set-top box coupled to a television set, etc. may be used for terminals 104.

Each user terminal 104 generally provides input and output devices (e.g., a keyboard and a monitor) for a user 108. Users 108A, 108B, and 108D-108F are shown in FIG. 2 using the terminals 104A, 104B, and 104D-104F respectively. In the example above, a user 108 may be a student, if the SRC system is deployed in a classroom setting. In one embodiment, each user 108 is authenticated to the SRC system. For example, a basic or “light authentication” may be employed to authenticate each user 108 to the SRC system. As described below, a light authentication may include matching the user's likeness to a name on a list, for example. In an embodiment, as illustrated in FIGS. 1 and 2, one of the users may also be an administrator 106. In that example, the user may login to one of the peripheral devices 104 using an additional level of authentication. For example, an additional level of authentication may include a username and password. Using an additional level of authentication may authenticate a user 108 as the administrator 106 for the SRC system.

In an embodiment, the SRC system is configured to share and exchange information between peripheral devices 104. For example, the SRC system can be configured to allow one user to share a document that the user is working on with a second user on the system. In an example embodiment, the SRC system is configured to generate a GUI 210 representing the physical environment of the SRC system. In one example, the GUI 210 represents the actual physical environment, including the conference room, class room, or setting, and the physical location, or relative location, of each of the peripheral devices 104. The GUI 210 may be displayed on one or more of the peripheral devices 104. For example, FIG. 2 illustrates a GUI 210 that may be displayed on peripheral device 104F. Further, a user 108 may be able to share information, such as documents, with another user 108 via the GUI 210 displayed on the associated peripheral device 104.

In an embodiment, the SRC system is further configured to associate an avatar 212 with each of the peripheral devices 104. The avatars 212 may be displayed within the representation of the physical environment of the GUI 210. In one example, the avatars 212 are displayed within the GUI 210 based on the physical location and relative position of each of the peripheral devices 104. As shown in FIG. 2, avatars 212A, 212B, 212D-212F are shown within the graphical representation of the physical environment of GUI 210, and are associated with peripheral devices 104A, 104B, 104D-104F, and thus, are also associated with users 108A, 108B, 108D-212F, respectively. In one example, as illustrated in FIG. 2, an avatar 212 may be displayed within the GUI 210 when a user 108 is present at a peripheral device 104, while no avatar 212 may be displayed within the GUI 210 for a peripheral device 104 having no user 108 present. In one example, an avatar 212 may be displayed when a user 108 is authenticated to a session via the peripheral device 104. In an alternate embodiment, the SRC system is further configured to associate an avatar 212 with a group of users or devices.

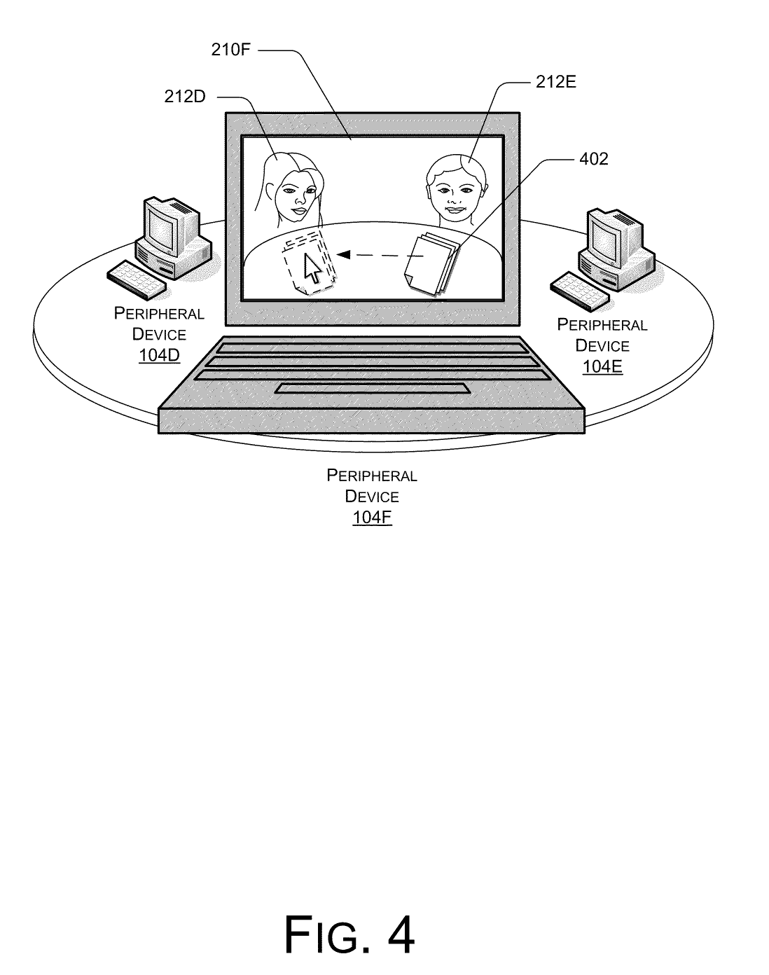

In an embodiment, the graphical representation of the physical environment and the avatars 212 may be used to share and exchange information between peripheral devices 104, and thus users 108. As will be described in more detail with reference to FIG. 4, a document may be sent to a peripheral device 104 (user 108) by dragging and dropping a symbol of the document within the GUI 210. In one illustrative example, user 108F may be working on a presentation document, and may wish to send a copy of the document to user 108A. In one embodiment, the document may be symbolized within GUI 210F. In that case, user 108F may drag the symbol of the document being displayed within the GUI 210F to the avatar 212A representing peripheral device 104A and user 108A. In this example, a copy of the document is sent to peripheral device 104A. Then, user 108A may view or edit the received document at peripheral device 104A. In alternate examples, an original document may be moved from one peripheral device to another peripheral device, a copy of a document may be made at one peripheral device and sent to another peripheral device, or a user can share a document with one or more users or peripheral devices by providing access to the same copy of the document stored on the SRC server.

### Illustrative Server and Functionality

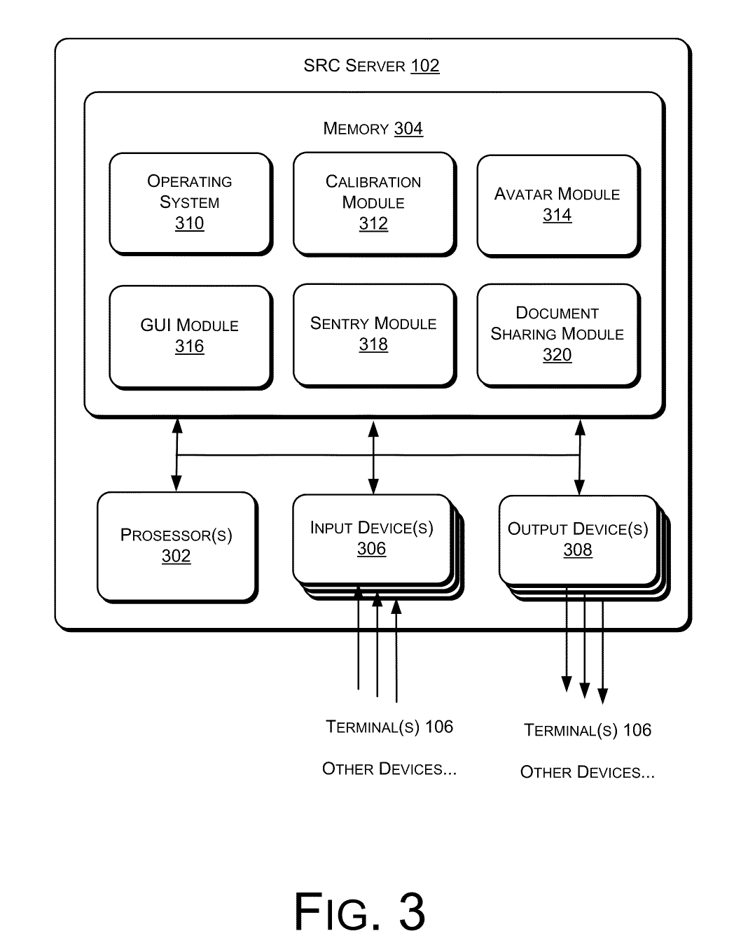

FIG. 3 shows a block diagram of an illustrative SRC server 102. An example SRC server 102 may include processor(s) 302, and memory 304 coupled to the processor(s) 302. The processor(s) 302 may be implemented as appropriate in hardware, software, firmware, or combinations thereof Software or firmware implementations of the processor(s) 302 may include computer- or machine-executable instructions written in any suitable programming language to perform the various functions described.

Memory 304 may store programs of instructions that are loadable and executable on the processor(s) 302, as well as data generated during the execution of these programs. Depending on the configuration and type of SRC server 102, memory 304 may be volatile (such as RAM) and/or non-volatile (such as ROM, flash memory, etc.). The SRC server 102 may also include additional removable storage and/or non-removable storage including, but not limited to, magnetic storage, optical disks, and/or tape storage. The disk drives and their associated computer-readable media may provide non-volatile storage of computer readable instructions, data structures, program modules, and other data.

Computer-readable storage media includes volatile and nonvolatile, removable and non-removable media implemented in any method or technology for storage of information such as computer-readable instructions, data structures, program modules or other data. Memory 304 is an example of computer-readable storage media. Additional types of computer-readable storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by the SRC server 102.

The example SRC server 102 may also include multiple input devices 306 and multiple output devices 308 for interfacing with peripheral devices 104. Input signals from peripheral devices 104 may be handled by input devices 306, and output signals for peripheral devices 104 may be handled by output devices 308. In alternate embodiments, input devices 306 and output devices 308 may also handle input and output signals respectively for other devices on the system. For example, each terminal may include input devices such as a keyboard, mouse, camera, pen, voice input device, touch input device, stylus, and the like, and output devices such as a display, monitor, speakers, printer, etc. All these devices are well known in the art and need not be discussed at length.

The SRC server 102 illustrates an example architecture of the above components residing on one device. Alternatively, these components may reside in multiple other locations, servers, or systems. For instance, all of the components may exist on a remote server. Furthermore, two or more of the illustrated components may combine to form a single component at a single location. The illustrated components may also reside in an SRC server 102 without a connection to a network, such as a stand-alone desktop or laptop computing device.

In one embodiment, modules configured to provide functionality to the SRC system may be stored in the memory 304 and executable on the processor(s) 302. For example, an operating system 310 may be stored in the memory 304 and executable on the processor(s) 302. Additionally, other modules stored in the memory 304 and executable on the processor(s) 302 may include a calibration module 312, an avatar module 314, a graphical user interface (GUI) module 316, a sentry module 318, and a document sharing module 320. In alternate embodiments, fewer modules may be present. In other embodiments, additional modules may be stored in the memory 304 to provide functionality to the SRC system.

If included, a calibration module 312 may be configured to detect a physical location of each of the peripheral devices 104. Additionally, the calibration module 312 may be configured to determine the relative position of each of the peripheral devices 104 with respect to each other. In one embodiment, the calibration module 312 may be configured to determine the relative position of each of the peripheral devices 104 based on their physical location within the actual physical environment. Thus, the calibration module 312 may be configured to calibrate the room or environment where the SRC system is operational. In general, the SRC system knows and understands the logical connections of the system, including the logical connections of the peripheral devices 104. Through the calibration module 312, the SRC system also understands the layout of the room or environment as well as the location of the various components of the system, including the location of each of the peripheral devices 104.

For example, in one embodiment the SRC system may include one or more cameras configured to provide input to the calibration module 312, to detect the physical location and to determine the relative position of each of the peripheral devices 104. Cameras configured for this purpose may be located at the SRC server 102, at one of the peripheral devices 104, and/or at other locations within the room or environment in such a way as to capture images and/or location information. The images and/or location information may allow the calibration module 312 to detect the physical location and to determine the relative position of various components of the system, including the location of each of the peripheral devices 104. Further, the images and or location information may also allow the calibration module 312 to determine the overall layout of the actual room or physical environment. This calibration may be accomplished using any of a variety of known facial and object recognition software, for example.

Additionally or alternatively, the SRC system may include a number of radio frequency (RF) transceivers configured to provide input to the calibration module 312 to detect the physical location and to determine the relative position of each of the peripheral devices 104. For example, the SRC server 102 and/or each of the peripheral devices 104 may include a RF transceiver configured to communicate location information to the calibration module 312. Again, this location information may allow the calibration module 312 to detect the physical location and to determine the relative position of various components of the system, including the location of each of the peripheral devices 104, within the layout of the room or environment.

In an embodiment, an avatar module 314 may be configured to associate an avatar 212 to each of the peripheral devices 104. In one embodiment, the avatar module 314 may be configured to create the avatar 212. In another embodiment, a user 108 or an administrator 106 may create the avatar 212. In other embodiments, the avatar 212 may be created in another way, for example, the avatar 212 may be imported from a network 110 location, such as the Internet. In any case, the avatar module 314 may be configured to associate an avatar 212 to a peripheral device 104 (and thus a user 108), such that each peripheral device 104 having a user 108 has an associated avatar 212.

Typically the avatars 212 will be uniquely distinguishable from each other to the SRC system, since, as will be detailed below, information such as documents may be shared between peripheral devices 104 by dragging a symbol of the document to an avatar 212 representing an intended recipient peripheral device 104. This may be accomplished by assigning unique identification tags, colors, symbols, or other identifiers to the avatars 212, for example. Generally, the avatars 212 will also be distinguishable from each other to the users 108, so that the users 108 know which peripheral device 104, and thus which user 108, they are sending a document to. In one embodiment, each avatar 212 has a unique appearance. In other embodiments, an avatar 212 may be unique in some other way. For example, an avatar 212 may have a unique animation. In one embodiment, an avatar 212 may be based on some physical characteristic of the user 108 of the associated peripheral device 104. For example, an avatar 212 may appear to have a same gender, hair color, clothing color, or the like, of the user 108. Additionally, the avatar 212 may appear to have accessories similar to those of the user 108, for example, a hat, a pair of glasses, or the like. In one embodiment, an avatar 212 may be based on an image of the user 108, for example, an image from a camera, an image file, or the like.

In an embodiment, a graphical user interface (GUI) module 316 may be configured to generate a GUI 210 and display avatars 212 within a graphical representation of the physical environment. In one example, the avatars 212 are displayed within the representation of the physical environment based on the physical location and relative position of each of the peripheral devices 104. For example, the calibration module 312 may detect the physical location of each peripheral device 104, the relative position of each of the peripheral devices 104 with respect to each other, and/or the relative position of each of the peripheral devices 104 with respect to the room or environment. Thus, with this information, the GUI module 316 can display the avatars 212 within a graphical representation of the physical environment, where the representation resembles the room or environment, and each avatar 212 is positioned within the representation corresponding to the physical location of the peripheral device 104 the avatar 212 is associated to. That is, the graphical representation of the physical environment may resemble the actual room where the peripheral devices 104 are located, and may include avatars 212 displayed in a spatially relative position corresponding to the physical location of the peripheral devices 104 in the actual room or environment.

In one embodiment, each peripheral device 104 includes a display showing the graphical representation of the physical environment within a GUI 210. In an example, the graphical representation of the physical environment showing on a peripheral device 104 may be displayed from the perspective of that peripheral device 104. For example, the graphical representation displayed on a peripheral device 104 may show the avatars 212 as the user 108 of the peripheral device 104 would see the other users 108, in terms of the relative position of their associated peripheral devices 104. In an example, the graphical representation may include various features of the room such as the shape of the room, furniture in the room, and the like.

If included, a sentry module 318 may be configured to authenticate the users 108 of the peripheral devices 104 to a session operative on the SRC server 102 and to provide the users 108 with access to resources stored on the SRC server.

In one example, the sentry module 318 may be configured to authenticate the users 108 using a light authentication, for example, without requiring a user name or password. In one embodiment, authentication may be automatic or semi-automatic. For example, in one embodiment, the sentry module 318 may receive an image of the room or environment from a camera. The sentry module 318 may automatically authenticate a user 108 based on the image received from the camera. In one embodiment, the camera may be configured to capture the image when the user 108 is present at one of the peripheral devices 104. In a further embodiment, the sentry module 318 may automatically authenticate the user 108 based on a facial recognition of the image received from the camera. For example, facial recognition functionality may be used in such an embodiment, where the facial recognition functionality includes processing an image received, and making comparisons of features of the image received to images stored in memory or in other computer-readable storage media. Other types of biometrics such as fingerprint or voice recognition functionality may also be used by the sentry module 318 to authenticate the user 108 to a session operative on the SRC server 102.

In one embodiment, the sentry module 318 may be configured to automatically authenticate users 108 of the peripheral devices 104 to a session operative on the SRC server 102 based on images or data from barcodes or tags recognized. For example, the sentry module 318 may receive an image of a barcode or a tag from a camera or a scanning device. In another embodiment, the sentry module 318 may receive data based on a barcode or a tag from a camera or a scanning device. The sentry module 318 may then authenticate a user 108 upon recognition of the image or the data received. Barcodes or tags may include common “stripe” type barcodes, binary barcodes, graphical barcodes and tags, 2D tags, RFID tags, and the like. Graphical barcodes and tags and 2D tags may include unique graphical designs and/or patterns used for identification and/or association. One example includes Microsoft® tags. Barcodes and tags used for these purposes may be computer-generated, user generated, and the like.

In one embodiment, the sentry module 318 may be configured to automatically authenticate a user 108 of a peripheral device 104 to a session operative on the SRC server 102 based on other images received and recognized. In one embodiment, the sentry module 318 may receive an image of an electronic display from a camera or scanning device. For example, the electronic display may be one from a mobile telephone, a personal digital assistant (PDA), a pocket personal computer, and the like. In one example, a user 108 may allow a camera or other scanning device to image or scan the electronic display of the user's mobile electronic device. The sentry module 318 may recognize the image or scans received, and automatically authenticate the user 108 to a session based on the image or scan received. In one embodiment, the session that the user 108 is authenticated to is determined by the image or scan received by the sentry module 318.

In one embodiment, a user 108 may provide a user name and a password to receive access to advanced functionality, the user name and password providing an additional level of authentication. For example, an administrator 106 may be automatically authenticated to the SRC server 102, or may be required to provide a user name and password to receive access to administrator functionality on the SRC server 102. This may be the case when a user 108 is also an administrator 106. In other embodiments, a user 108 and/or an administrator 106 may be required to provide other types of credentials to receive access to advanced functionality.

In one embodiment, the sentry module 318 may be configured to authenticate a user 108 to a session operative on the SRC server 102 based on manual association of an image of a user 108 to a name on a roster. In one example, the manual association of the image of the user 108 to the name on the roster is performed by a drag and drop operation. For example, an administrator 106, having access to advanced functionality, may drag an image of a user 108 to the user's name on a register or roster, authenticating the user 108 to a session. In a classroom example, the administrator 106 may be a teacher; and the teacher may drag an image of a student to the student's name on a class roll. In other embodiments, other methods may be performed to associate an image of a user 108 to the user's name on a register or roster. Further, in other embodiments, other manually performed methods of authorization and/or authentication of users 108 may be used.

In one embodiment, the sentry module 318 is configured to provide each of the users 108 access to resources stored on the SRC server (e.g., documents, files, databases, applications, controls, etc.). The sentry module 318 may be further configured to grant or deny user access to documents during document sharing as described below. For example, the sentry module 318 may determine whether a user 108 has read, read/write, or no access to a document, when another user is attempting to share the document with the user 108. This may result in the user 108 receiving access to the original document, or receiving a copy of the document (if anything at all) during document sharing.

In an embodiment, a document sharing module 320 may be configured to send a document to one or more of the peripheral devices 104, and thus users 108. For instance, the document sharing module 320 may be configured to send a document from one peripheral device 104 to one or more other peripheral devices 104, where the sending may include transferring an original document to a peripheral device, transferring a copy of a document to a peripheral device, or sharing a document by providing a user or device access to the single copy of the document on the SRC server, such that both devices (users) may view and/or edit the document concurrently. In one example, the document sharing module 320 may be configured to send the document to a peripheral device 104 by a drag and drop operation, as illustrated in FIG. 4. In other examples, the document sharing module 320 may be configured to send the document to a peripheral device 104 by other methods. For example, the document sharing module 320 may be configured to send the document in response to keystrokes, commands, voice commands, timing, or other triggers.

### Illustrative Sharing Process

In an illustrative example, as shown in FIG. 4, a symbol 402 of a document to be sent is displayed within the GUI 210F of the sending peripheral device 104F. The user 108F (not shown) drags and drops the symbol 402 of the document to the avatar 212D associated with the receiving peripheral device 104D. The user 108F may drag and drop the symbol 402 of the document using a pointing device such as a mouse, touch pad, touch screen, a gesture, keystroke(s), or the like.

In an embodiment, when a symbol 402 of the document is dropped onto an avatar 212 of a receiving peripheral device 104, the document is sent to the receiving peripheral device 104. In one embodiment, the document is open during the sending. That is, the document may be open for viewing, editing, or the like, by the sending peripheral device 104 when a user 108 drags and drops the symbol 402 of the document to an avatar 212 of a receiving peripheral device 104. As a result, the document is sent to the receiving peripheral device 104. In another embodiment, when a user 108 drags and drops the symbol 402 of the document on an avatar 212, the sentry module 318 provides the user or device associated with the avatar 212, access to the document.

In an embodiment, the document may be sent to multiple peripheral devices 104 concurrently. For example, in FIG. 4, the user 108F (not shown) may select both avatars 212D and 212E to be recipients of the document to be sent. User 108F may then drag and drop the symbol 402 of the document to both avatars 212D and 212E by dragging it to one of the avatars 212, for example, while both are selected, thereby sending the document to both peripheral devices 104D and 104E. In one example, both avatars 212D and 212E may be selected by mouse-clicking on one of them, and then mouse-clicking on the other while holding the <CTRL> key. In other examples, both avatars 212D and 212E may be selected by other methods, such as a combination of keyboard strokes. Further, in an embodiment, a document may be sent to multiple peripheral devices 104 while the document is open.

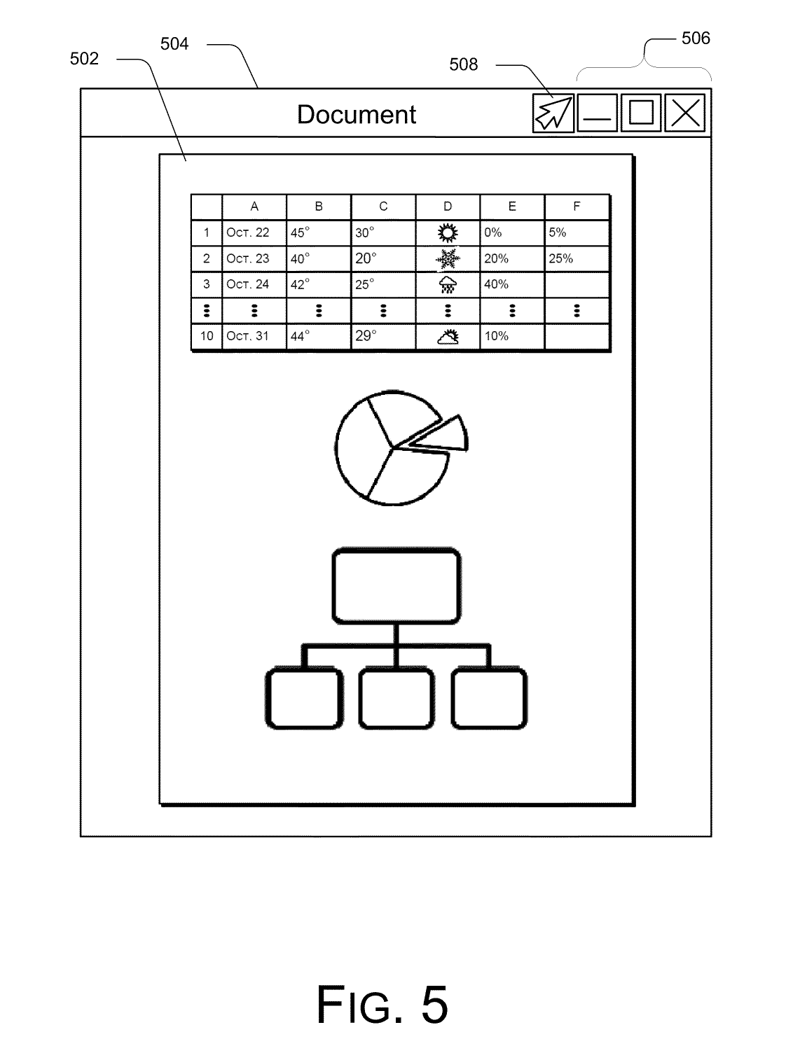

FIG. 5 is an illustration of a document 502 opened in a document editing and/or viewing application 504, according to an example embodiment. For example, the document 502 may be opened in the document editing and/or viewing application at one of the peripheral devices 104. In the illustration of FIG. 5, the document 502 is open for viewing and/or editing in an application for word processing such as Microsoft® Word, an application for creating/editing presentations such as Microsoft® PowerPoint, a document editing/publishing application such as Microsoft® Publisher or Microsoft® Visio, or the like. In an embodiment, the document 502 may be sent to another peripheral device 104 while the document 502 open for editing and/or viewing via a first peripheral device 104 as shown.

In an embodiment, the application 504 may have a number of icons 506 for providing functionality to the user 108. In one embodiment, the application 504 may have an additional icon 508 for providing document sharing and exchanging functionality to the user 108. In an alternate embodiment, the icon 508 may be displayed within the document 502 or in another location. In an example, the user 108 can select the icon 508 to send the document 502 to one or more peripheral devices 104. For example, a symbol 402 of the document 502 may be displayed when the icon 508 is selected. The user 108 may then drag and drop the symbol 402 of the document to one or more avatars 212, thereby sending the document to respective one or more peripheral devices 104. Additionally or alternately, the application 504 or the document 502 may have other controls (e.g., drop-down menus, keystrokes, input controls, etc.) for providing document sharing and exchanging functionality to the user 108.

In one embodiment, selecting an icon 508 causes a symbol 402 of the document 502 to be displayed within a graphical representation of the room or environment. In one example, a symbol 402 may represent “send the document,” “send a copy of the document,” or “share the document.” A user 108 may indicate what type of send is desired when selecting the icon 508. For example, if a user 108 wishes to send the original of the document 502 to one of the peripheral devices 104, the user 108 may make a selection, for instance from a drop down menu, when selecting the icon 508. In another example, if a user 108 wishes to send a copy of the document 502 to one of the peripheral devices 104, the user 108 may make that selection, for instance from the drop down menu, when selecting the icon 508. Further, if a user 108 wishes to share the document 502 with one or more peripheral devices 104 (e.g., for simultaneous collaboration), the user 108 may make that selection, for instance from the drop down menu, when selecting the icon 508. In other embodiments, the user 108 may indicate what type of send is desired for sending the document 502 to one or more peripheral devices 104 by some other method. In one alternate embodiment, additional icons 508 may be displayed within the editing and/or viewing application 504 or the document 502, where each additional icon 508 indicates what type of send is desired. In further embodiments, other controls (e.g., drop-down menus, keystrokes, input controls, a touch pad, gestures, etc.) may be additionally or alternately displayed where each additional control indicates what type of send is desired.

In an embodiment, the symbol 402 may represent “send the document,” “send a copy of the document,” or “share the document” by the appearance of the symbol 402. In another embodiment, the symbol 402 may represent “send the document,” “send a copy of the document,” or “share the document” by a unique property of the symbol 402 for each type of send, such as animation, color, sound, border, and the like. In a further embodiment, multiple symbols 402 of the document 502 representing each type of send are displayed within the graphical representation of the room or environment when a user 108 selects an icon 508.

In an embodiment, the document 502 is sent to the receiving peripheral device 104 when the symbol 402 of the document 502 representing “send the document” is dragged and dropped to a receiving avatar 212. In this case, the sending peripheral device 104 no longer has possession of the document 502. Additionally, when the symbol 402 of the document 502 representing “send a copy of the document” is dragged and dropped to a receiving avatar 212, a copy of the document 502 is sent to the receiving peripheral device 104, and the sending peripheral device 104 retains the original copy of the document 502. Further, when the symbol 402 of the document 502 representing “share the document” is dragged and dropped to a receiving avatar 212, the receiving peripheral device 104 is able to edit and/or view the document 502 concurrently with the sending peripheral device 104. In alternate embodiments, other functionality may also be available when the symbol 402 of the document 502 is dragged and dropped to a receiving avatar 212.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that can be implemented in hardware, software, or a combination of hardware and software. For discussion purposes, the processes are described with reference to the system shown in FIGS. 1-5. However, the processes may be performed using different architectures and devices.

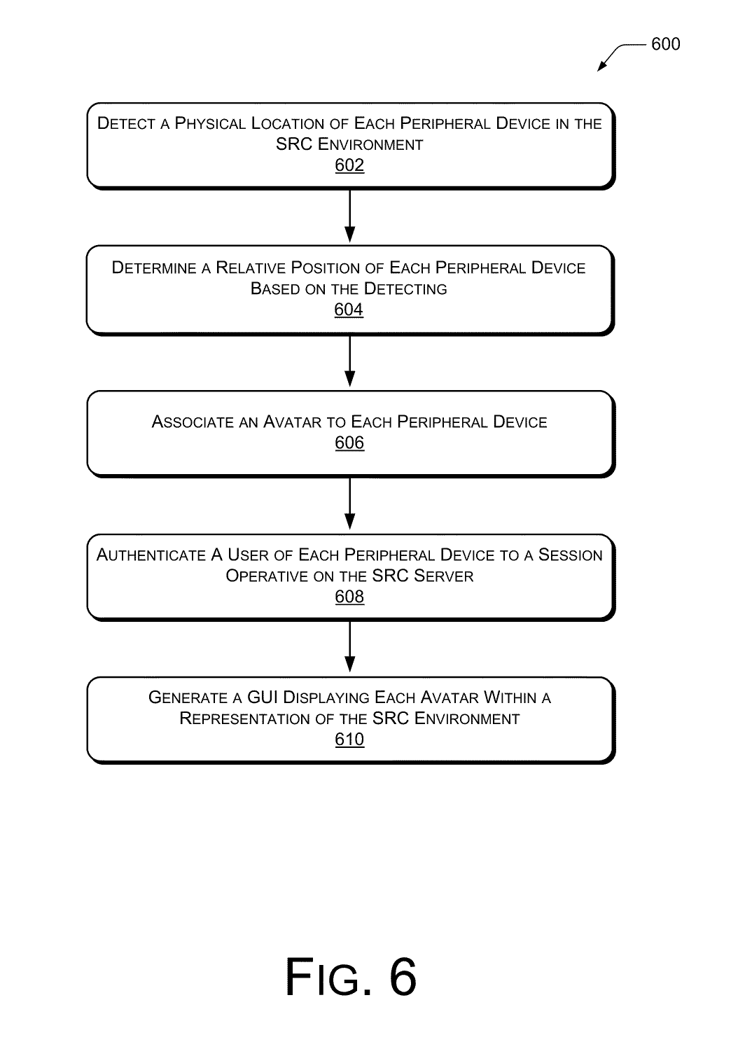

FIG. 6 is a flowchart illustrating a method of configuring a shared resource computing (SRC) environment for sharing and exchanging information between devices in the SRC environment, according to an example embodiment. At block 602, a physical location of each peripheral device 104 in the SRC environment is detected. In one example, each peripheral device 104 is sharing a common SRC server 102. In alternate embodiments, more than one SRC server 102 may be present in an SRC system; however multiple SRC servers are shared by the peripheral devices 104, and provide the general computing resources for the peripheral devices 104. In one embodiment, the SRC environment is a room, such as a conference room, classroom, or the like. For example, the peripheral devices 104 may be co-located in a common room, the common room comprising the SRC environment.

In one embodiment, the physical location of each peripheral device 104 is detected based on input, such as an image, from a camera. In another embodiment, the physical location of each peripheral device 104 is detected based on input from one or more radio frequency (RF) transceivers or by WiFi triangulation. In alternate embodiments, the physical location of each peripheral device 104 is detected based on other input and/or methods.

At block 604, a relative position of each peripheral device 104 is determined. In one example, the relative position of each peripheral device 104 is determined based on the detecting described in block 602. In one embodiment, the SRC system is calibrated, or understands the layout of the room based on the determining and/or detecting described above.

At block 606, an avatar 212 is associated to each peripheral device 104. In an embodiment, each avatar 212 is unique and distinguishable from the other avatars 212. In one example, each avatar 212 is configured to represent a user 108 of an associated peripheral device 104, at least in part for sending and receiving documents between sessions operative on the SRC server 102. For example, each avatar 212 may be configured to appear within a graphical representation of the SRC environment when an associated user 108 logs onto a session on the SRC server 102. Further, in an example, a document may be sent between peripheral devices 104, where the peripheral devices 104 are hosting sessions operative on the SRC server 102, by performing operations using the avatars 212.

At block 608, a user 108 of each peripheral device 104 is authenticated to a session operative on the SRC server 102. In one embodiment the user 108 may be automatically authenticated to a session operative on the SRC server 102 based on an image of the SRC environment received from a camera. For example, the camera may be configured to capture an image when a user 108 is present at one of the peripheral devices 104. In an embodiment, the user 108 may be automatically authenticated to a session operative on the SRC server 102 based on facial recognition of the image received from the camera. For example, a facial analysis or facial recognition process as described above may be employed to automatically authenticate users 108.

In an embodiment, a user 108 may be automatically authenticated to a session operative on the SRC server 102 based on an image of a barcode or tag. For example, the image of the barcode or tag may be received by a camera or scanning device. In one embodiment the user 108 may be automatically authenticated to a session by recognition of the barcode or tag. In an alternate embodiment, data may be received from the camera or scanning device in addition to or instead of an image, the user 108 being automatically authenticated based on the data. Further, in an embodiment, the user 108 may be automatically authenticated to a session operative on the SRC server 102 based on an image of an electronic display received from a camera or scanning device. For example the electronic display may be from one of a mobile telephone, a personal digital assistance (PDA), a pocket personal computer, or the like.

In another embodiment, authenticating a user 108 further comprises using a user name and a password. For example, a user 108 may enter a user name and a password for an additional level of authentication, providing access to advanced functionality.

In a further embodiment, authenticating a user 108 is performed manually. For example, an image of the user 108 may be associated to a name on a roster, for example, by a drag and drop operation. In one example, an administrator 106, having access to advanced functionality, may perform the drag and drop operation.

At block 610 a graphical user interface (GUI) is generated. In one embodiment, the GUI 210 is configured to display avatars 212 within a representation of the SRC environment. In an embodiment, the GUI 210 is configured to display each avatar 212 in a spatially relative position corresponding to the physical location of each of the peripheral devices 104 in the SRC environment. For example, the GUI 210 can display the avatars 212 within a graphical representation of the SRC environment, where the representation resembles the room or environment, and each avatar 212 is positioned within the representation relative to the physical location of the avatar's associated peripheral device 104.

In one embodiment, the appearance or characteristics of an avatar 212 is based at least in part on physical characteristics of the user 108 of the associated peripheral device 104. For example, an avatar 212 may resemble the user 108 in physical appearance. In one embodiment the avatar 212 may be based upon an image, such as a photograph or digital image of the user 108.

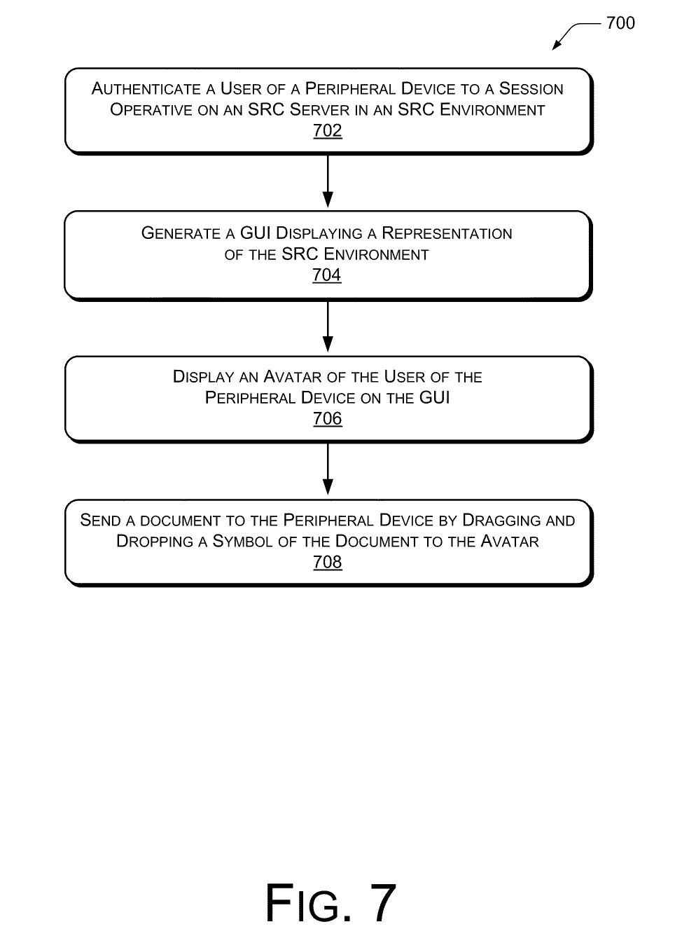

FIG. 7 is a flowchart illustrating a method of sharing and exchanging a document between devices in an SRC environment, according to an example embodiment. At block 702, a user 108 of a peripheral device 104 is authenticated to a session operative on an SRC server 102 in an SRC environment. The user 108 may be authenticated to a session as discussed above. In other embodiments the user 108 may be authenticated to a session by some other method.

At block 704, a GUI 210 displaying a representation of the SRC environment is generated. For example, a GUI 210 displaying a representation of the SRC environment may be generated at one or more peripheral devices 104 or at each peripheral device 104.

At block 706, an avatar 212 of the user 108 of the peripheral device 104 is displayed on the GUI 210. In an embodiment, each peripheral device 104 having a user 108 authenticated to a session via the peripheral device 104 has an associated avatar 212 displayed within the GUI 210. In one example, each avatar 212 is displayed within the GUI 210 in a relative position corresponding to the physical location of the associated peripheral device 104 within the SRC environment. For example, each avatar 212 may be displayed within the GUI 210 in a position relative to each other avatar 212 corresponding to the relative positions of the peripheral devices 104 in the room or environment.

At block 708, a document 502 is sent to the peripheral device 104. For example, the document 502 may be sent by dragging and dropping a symbol 402 of the document 502 to the avatar 212 associated with the peripheral device 104. In one embodiment, the document 502 is open for viewing and/or editing during the sending. For example, the document 502 may be open for editing and/or viewing within an editing and/or viewing application while the document is sent to the peripheral device 104.

In one embodiment, the document 502 may be sent to multiple peripheral devices 104 concurrently. In one embodiment, the document 502 may be sent concurrently to multiple peripheral devices 104 by dragging and dropping a symbol 402 of the document 502 to multiple selected avatars 212. For example, several avatars 212 may be selected via the GUI 210 prior to the sending. In another example, the avatars 212 may be selected by another means, keystrokes for example, prior to the sending.

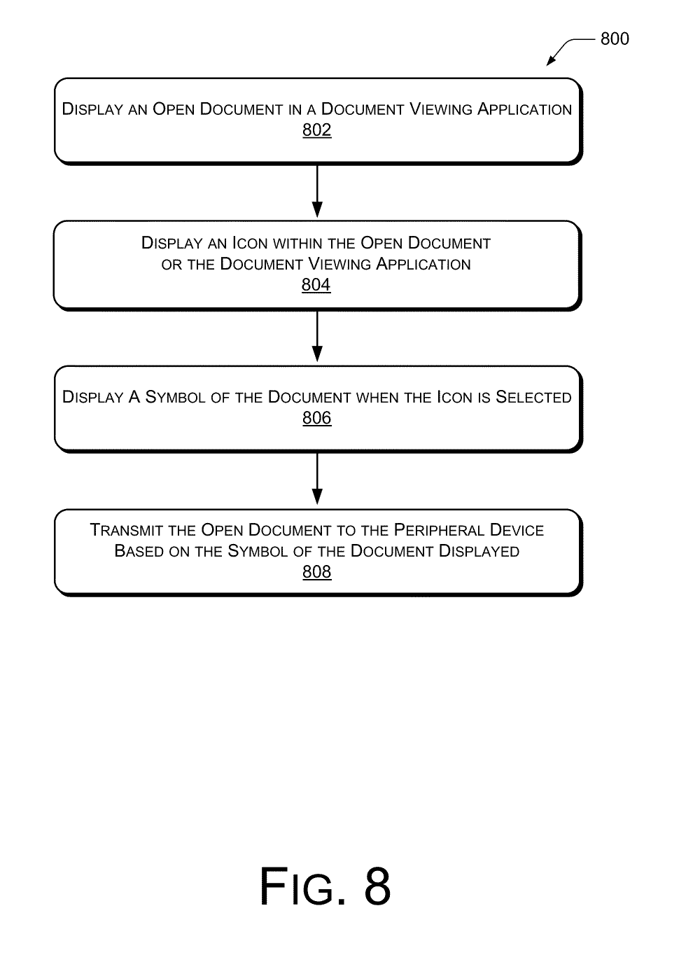

FIG. 8 is a flowchart illustrating a method of moving a document between peripheral devices, according to an example embodiment. At block 802, an open document 502 is displayed in a document viewing application 504. In another embodiment, the open document 502 may be displayed in an application for editing and/or viewing the document 502.

At block 804, an icon 508 is displayed within the open document 502 or the editing and/or viewing application 504. In an alternate embodiment, multiple icons 508 are displayed within the open document 502 or the editing and/or viewing application 504. For example, multiple icons 508 representing one of sending the document, sending a copy of the document, or sharing the document may be displayed.

At block 806, a symbol 402 of the document 502 is displayed within the GUI 210 when an icon 508 is selected. For example, a user 108 may mouse-click on an icon 508, thereby causing a symbol 402 of the document 502 to be displayed within the GUI 210. In alternate embodiments, the user 108 may cause the symbol 402 of the document 502 to be displayed within the GUI 210 by other methods, for example, touch or gesture on a display. In a further embodiment, multiple symbols 402 may be displayed within the GUI 210 when an icon 508 is selected. For example, multiple symbols 402 representing one of sending the document, sending a copy of the document, or sharing the document may be displayed.

At block 808, the document 502 is transmitted to a peripheral device 104 based on the symbol 402 of the document 502. For example, the document 502 may be sent to the peripheral device 104, a copy of the document 502 may be sent to the peripheral device 104, or the document 502 may be shared with the peripheral device 104 based on the symbol 402 of the document 502 that is displayed (and/or selected).

In one embodiment, the symbol 402 is animated. For example, the symbol 402 may be animated to indicate one of sending the document, sending a copy of the document, or sharing the document. In one example, multiple symbols 402 are animated. For instance, each symbol 402 may be animated to indicate each of sending the document, sending a copy of the document, or sharing the document.

### Conclusion

The subject matter described above can be implemented in hardware, software, or in both hardware and software. Although implementations of an SRC system have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of controlling access to resources. For example, the methodological acts need not be performed in the order or combinations described herein, and may be performed in any combination of one or more acts. Moreover, certain structural features and/or method acts may be omitted entirely in some circumstances.

1. A system for sharing and exchanging information between devices within a physical environment, the system comprising:
a plurality of peripheral devices sharing a common computing resource; and
a shared resource computing (SRC) server comprising:
a processor;
memory coupled to the processor;
a calibration module stored in the memory and executable on the processor, the calibration module configured to detect a physical location and to determine a relative position of each of the plurality of peripheral devices;
an avatar module, stored in the memory and executable on the processor, the avatar module configured to associate an avatar to each of the plurality of peripheral devices; and
a graphical user interface (GUI) module stored in the memory and executable on the processor, the GUI module configured to display the avatars within a representation of the physical environment, the displaying based on the physical location and relative position of each of the plurality of peripheral devices.

2. The system of claim 1, further comprising a sentry module stored in the memory and executable on the processor, the sentry module configured to authenticate a user of each of the plurality of peripheral devices to a session operative on the SRC server, and to provide the user access to resources stored on the SRC server.

3. The system of claim 1, further comprising a document sharing module stored in the memory and executable on the processor, the document sharing module configured to send a document or provide access to the document to at least one of the plurality of peripheral devices, the sending or providing access comprising a drag and drop operation of a symbol of the document to an avatar associated with the at least one of the plurality of peripheral devices, wherein the document is open during the sending or providing access.

4. The system of claim 1, further comprising a camera configured to provide input to the calibration module to detect the physical location and to determine the relative position of each of the plurality of peripheral devices.

5. The system of claim 1, further comprising a plurality of radio frequency transceivers configured to provide input to the calibration module to detect the physical location and to determine the relative position of each of the plurality of peripheral devices.

6. A method for sharing and exchanging information between devices in a shared resource computing (SRC) environment, the method comprising:
detecting a location of each of a plurality of peripheral devices sharing a common SRC server;
determining a position of each of the plurality of peripheral devices based on the detecting;
associating an avatar to each of the plurality of peripheral devices, each avatar configured to represent a user of the associated peripheral device at least in part for sending and receiving documents between sessions operative on the SRC server;
authenticating the user of the associated peripheral device to a session operative on the SRC server; and
generating a graphical user interface (GUI) configured to display each avatar within a representation of the SRC environment.

7. The method of claim 6, wherein the generating the GUI comprises generating a GUI configured to display each avatar in a spatially relative position corresponding to the physical location of each of the plurality of peripheral devices in the SRC environment.

8. The method of claim 6, wherein an appearance of the avatar is based at least in part on physical characteristics of the user of the peripheral device.

9. The method of claim 6, wherein the authenticating comprises:
receiving an image of the SRC environment from a camera, the camera configured to capture the image when a user is present at one of the plurality of peripheral devices, and
automatically authenticating the user based on the image received.

10. The method of claim 9, further comprising:
receiving an image of the user of the peripheral device from the camera, and
automatically authenticating the user of the peripheral device based on facial recognition of the image received.

11. The method of claim 9, further comprising:
receiving an image of a barcode or a tag from the camera, and
automatically authenticating the user of the peripheral device based on recognition of the barcode or tag image received.

12. The method of claim 9, further comprising:
receiving an image of an electronic display from the camera, the electronic display from one of a mobile telephone, a personal digital assistant (PDA), or a pocket personal computer, and
automatically authenticating the user of the peripheral device based on recognition of the image of the electronic display received.

13. The method of claim 9, wherein the authenticating further comprises an additional level of authentication for access to advanced functionality, the additional level of authentication including a username and a password.

14. The method of claim 6, wherein the authenticating comprises manually associating an image of the user of the peripheral device to a name on a roster by a drag and drop operation, by an administrator having access to advanced functionality.

15. A method for sharing and exchanging information between devices in a shared resource computing (SRC) environment, the method comprising:
authenticating a user of a first peripheral device to a session operative on an SRC server in the SRC environment;
generating a graphical user interface (GUI) configured to display a representation of the SRC environment and an avatar of the user of the first peripheral device; and
sending a document to the first peripheral device from a second peripheral device.

16. The method of claim 15, wherein the sending comprises a drag and drop operation, operative on the GUI, of a symbol of the document to the avatar of the user of the first peripheral device.

17. The method of claim 15, wherein the document is open for viewing and/or editing at the second peripheral device during the sending.

18. The method of claim 15, wherein the sending further comprises concurrently sending the document to a plurality of peripheral devices.

19. The method of claim 15, wherein the sending further comprises:
displaying the document in a document viewing application at the second peripheral device, the document displayed in an opened state;
displaying an icon within one of the open document or the document viewing application;
displaying a symbol of the document within the representation of the SRC environment when the icon is selected, the symbol of the document representing one of: send the document, send a copy of the document, or share the document; and
transmitting the document to the first peripheral device, transmitting a copy of the document to the first peripheral device, or sharing the open document with the first peripheral device, respectively, based on the symbol of the document displayed when the icon is selected.

20. The method of claim 19, wherein the displaying the symbol of the document comprises displaying an animated symbol of the document, the symbol being animated to indicate the one of: send the document, send a copy of the document, or share the document.
